(19) United States
(12) Patent Application Publication
(10) Pub. No.: US 2026/0109342 A1
(43) Pub. Date: Apr. 23, 2026

(54) LOAD UNIT HAVING A SENSOR MODULE, AND SENSOR MODULE FOR A LOAD UNIT

(71) Applicant: Volkswagen Aktiengesellschaft, Wolfsburg (DE)

(72) Inventors: Daniel SCHUETZ, Wolfsburg (DE); Frank PETERSHAGEN, Wolfsburg (DE)

(73) Assignee: Volkswagen Aktiengesellschaft, Wolfsburg (DE)

(21) Appl. No.: 19/361,777

(22) Filed: Oct. 17, 2025

(30) Foreign Application Priority Data
Oct. 17, 2024 (DE) 10 2024 210 064.1

(51) Int. Cl. B60W 30/06; B60W 10/26; B60W 50/00

(52) U.S. Cl. CPC B60W 30/06; B60W 10/26; B60W 2050/0002; B60W 2300/12

(57) ABSTRACT

A load unit that can be flexibly configured for autonomous driving. The load unit is configured to receive at least one transport good and transport it on a drivable surface. A driving module with a drive battery and at least one electric drive for driving wheels of the load unit are provided. A control module includes a sensor system and a computing device. The computing device is designed to evaluate data of the sensor system and to calculate and output driving commands for autonomous driving of the load unit, using the data of the sensor system. The control module, including the sensor system and the computing device forms an integrated unit and is detachably fastenable to the driving module.

This nonprovisional application claims priority under 35 U.S.C. § 119(a) to German Patent Application No.10 2024 210 064.1, which was filed in Germany on Oct. 17, 2024, and which is herein incorporated by reference.

### BACKGROUND OF THE INVENTION

### Field of the Invention

The present invention relates to a load unit that is configured to receive at least one transport good and transport it on a drivable surface, having a driving module with a drive battery and at least one electric drive for driving wheels of the load unit, and a control module, the control module including a sensor system and a computing device, and the computing device being designed to evaluate data of the sensor system and to calculate and output driving commands for autonomous driving of the load unit, using the data of the sensor system.

The present invention further relates to a control module for a load unit.

### Description of the Background Art

In the land-based transport industry, numerous improvements and optimizations are possible using automation. For example, the increasing shortage of qualified truck drivers may be compensated for by using autonomously operated transport vehicles. In addition, for environmental reasons there is an increasing focus on electrically driven transport vehicles such as eTrucks. However, conversion to electrically operated transport units and autonomous driving is currently not cost-efficient. Control modules for autonomous driving are highly integrated into the transport vehicles in question. As a result, the cost-intensive technology for autonomous driving is always linked to the corresponding transport vehicle, thus reducing flexibility in the transport industry.

A horizontal transportation system for a completely automatic side-loading/unloading container terminal is known from US 2023/0072997 A1. The system includes a horizontal transportation device with an unmanned artificial intelligence robot of transportation (ART) and a horizontal transportation control system that intelligently manages and controls the ART.

WO 2020/028530 A1, which corresponds to US 2020/0039766, discloses a computer-implemented method for transporting cargo using smart pallets, including determining receipt of a first cargo item onto a platform of a first smart pallet at a first distribution hub, generating one or more signals that control the loading of the first smart pallet and the first cargo item onto a trailer located at the first distribution hub, determining a coordination with one or more second smart pallets associated with the trailer to determine a first position inside the trailer for the first smart pallet and the first cargo item, and generating one or more signals that position the first smart pallet and the first cargo item at the first position inside the trailer.

A system, based on an intelligent networking system, for controlling the automatic driving operation of trucks is known from CN 111260946 A. The system for automatic control of the truck operation includes a roadside unit (RSU) network, a traffic control unit (TCU), a traffic control center (TCC) network, a vehicle, an on-board unit (OBU) that is able to carry out a human/vehicle interaction between a human and a vehicle, a traffic operation center (TOC), and a cloud-based information and computing services platform.

### SUMMARY OF THE INVENTION

It is therefore an object of the present invention to provide a load unit that can be flexibly configured for autonomous driving.

The object underlying the invention is achieved by providing a load unit that is configured to receive at least one transport good and transport it on a drivable surface, having a driving module with a drive battery and at least one electric drive for driving wheels of the load unit, and a control module, the control module including a sensor system and a computing device, and the computing device being designed to evaluate data of the sensor system and to calculate and output driving commands for autonomous driving of the load unit, using the data of the sensor system, it being provided that the control module, including the sensor system and the computing device, forms an integrated unit and is detachably fastenable to the driving module. The computing device may have, for example, inputs and outputs, a processor or central processing unit, a memory storage, and is adapted to process data based on inputs and to provide processed data on its outputs.

The load unit may also include a steering system for the wheels, preferably for at least two of the wheels, and a braking system. Furthermore, the load unit may include a control device that receives the driving commands from the computing device of the control module and implements them by appropriate activation of the electric drive, the steering system, and/or the brakes.

The load unit can be characterized in that the control module, including the sensor system and the computing device, may form an integrated unit and is detachably fastenable to the driving module. The control module may thus be removed from the driving module of the load unit or placed on same. In other words, a driving module of a load unit that is not designed for autonomous driving may be used to provide a load unit that is configured for autonomous driving by detachably fastening the control module to the driving module.

Thus, in particular for a fleet of load units, one or more load units may be provided with autonomous driving functions in a flexible manner. Load units or driving modules that are not provided with the control module may be coupled to the load unit designed for autonomous driving by means of the control module, for example to form a combination as standard transport units.

The load unit may include no cab, in particular no driver's cab.

The control module can be designed to control the load unit during high-speed travel.

In particular, the control module can be designed to control the load unit during high-speed travel on expressways or public roadways. In particular, it is further provided that the control module is designed to allow the load unit to perform autonomous driving at speeds of at least 60 km/h, preferably at least 80 km/h, more preferably at least 90 km/h.

It is preferably provided that the sensor system can include cameras and/or radar sensors and/or lidar sensors and/or a V2X unit, in particular a V2V unit and/or a V2I unit and/or a V2P unit and/or a V2N unit.

By use of the sensor system, such as cameras, radar sensors, and/or lidar sensors, the control module of the load unit can detect the surroundings of the load unit and appropriately calculate and output driving commands for autonomous driving. The load unit preferably includes a V2X unit. A V2X unit is understood to mean a unit by means of which data may be exchanged with other road users or infrastructure facilities.

The load unit, in particular the driving module, preferably can include a control unit and a sensor device, wherein the control unit and the sensor device are configured to autonomously control the load unit during low-speed travel. Low-speed travel is understood to mean travel at speeds of less than 25 km/h, preferably less than 10 km/h, particularly preferably less than 5 km/h.

In particular, it is provided that the control unit and the sensor device may not be part of the sensor module and may not be integrated into the sensor module. In particular, the control unit and the sensor device can be integrated into the driving module. The driving module of the load unit can thus autonomously drive and maneuver at low speeds, in particular at walking speed, even without a control module situated thereon. This is advantageous in particular in logistics centers, truck stops, or other areas that are not part of the public transportation network. The control module is fastened to the load unit so that the driving module of the load unit can allow autonomous driving at higher speeds.

It is further advantageously provided that the control module includes communication devices for exchanging data with an external server and/or with the electric drive and/or other load units.

The communication device can be designed in particular for wireless, in particular radio-based, data exchange with an external server. When the communication device is designed for data exchange with a control device or the drive, or when the communication device is designed for exchanging data with load units that are put together to form a combination, the communication device may also be hard-wired.

When the control module includes communication devices for exchange with an external server, they may be used in particular for fleet management for a plurality of load units. In a platooning combination, in which multiple load units are coupled to form a combination of load units, data exchange with the other load units may take place via the communication device. The data that are exchanged in this case may include, among other things, information about the drive batteries of the particular load units, such as state of charge, aging, etc. In addition, by means of the communication device the control module may collect information about the transport good, the vehicle condition, and the sensor system of the other load units.

It is preferably provided that the control module has a power supply, in particular a battery, for supplying power to the computing device and/or the sensor system, the power supply preferably having a capacity for the basic supply of the computing device and/or the sensor system for at least three, preferably at least five, more preferably at least seven, days, and/or the power supply delivering a voltage of less than 60 V.

The control module is thus largely autonomous, and can be operated regardless of the state of charge of the drive battery of the load unit.

Furthermore, it may be provided that the control module can include a fastener for fastening to the driving module, wherein the fastener includes centering pins and/or a wedge guide and/or an electromagnetic positioning device.

The fastener is used to allow simple, secure fastening of the control module to the driving module of the load unit. By use of the electromagnetic positioning device, on the one hand precise positioning of the control module at the driving module may be ensured, and on the other hand the electromagnetic positioning device may assist with the placement of the control module at the driving module and magnetically attract the control module to the driving module. The fastener device also preferably includes a locking mechanism to prevent unintended detachment of the control module from the driving module.

Furthermore, it may advantageously be provided that the control module includes a cleaning device, in particular cleaning nozzles, for the sensor system.

Manual cleaning of the sensor system is thus no longer necessary. The cleaning device may also include a cleaning agent tank for a cleaning fluid that is dispensed through the cleaning nozzles.

Moreover, it is advantageously provided that the control module has aerodynamic cladding.

In addition, it may be provided that the control module has a charge interface for charging the battery via a stationary charging station.

The battery of the control module may thus be charged via a stationary charging station. In particular, it is not necessary for the battery of the control module to be charged via the drive battery of the load unit, even though this is possible in principle.

The charge interface can be an inductive charge interface or a charge interface with a plug attachment.

It is preferably provided that the load unit is designed, preferably by implementing driving commands of the control module, to approach the charging station and transfer the control module to the charging station or remove it from the charging station.

Thus, if the state of charge of the battery of the control module is low, by outputting appropriate driving commands the control module can instruct the load unit to approach the charging station and transfer the control module to the charging station. The battery of the control module is charged at the stationary charging station. After charging is completed, the control module may be removed from the charging station by a load unit. For this purpose, either the load unit may be designed to autonomously approach the charging station, or the control module sends in particular radio-based driving commands to the load unit to instruct it to approach the charging station and remove the control module.

Furthermore, it may advantageously be provided that the control module has receptacles for a carrying device of a forklift, in particular fork eyes for a fork of a lift truck.

A forklift, in particular a lift truck, may thus be used to remove the control module from the load unit or the driving module of the load unit. The fork of the lift truck is introduced into the fork eyes of the control module, and by means of the lift truck the control module may be transported to the stationary charging station or to another load unit.

A further approach to achieving the object underlying the invention involves a control module for an above-described load unit, the control module including a sensor system and a computing device, and the computing device being designed to evaluate data of the sensor system and to calculate driving commands, using the data of the sensor system, it being provided that the control module, including the sensor system and the computing device, forms an integrated unit and is detachably fastenable to the driving module of the load unit.

The control module can be designed in accordance with a control module of a load unit described above. All functions, features, and examples of the control module of the above-described load unit may also be analogously transferred to the control module according to the invention.

Yet a further approach to achieving the object underlying the invention involves a combination of multiple transport units, wherein a transport unit, preferably a first transport unit viewed in the forward travel direction of the combination, is an above-described load unit having a control module, and wherein each of the further transport units includes at least one driving module of an above-described load unit.

In the combination according to the invention, a transport unit, preferably the first transport unit viewed in the forward travel direction of the combination, can be designed as an above-described load unit having a control module situated at the driving module. The combination includes further transport units, but these do not necessarily have to have a control module. These further transport units are coupled to the first transport unit via appropriate coupling devices.

It may be provided that the control module of the transport unit configured as a load unit is designed to collect data concerning the drive batteries of the further transport units in the combination, and to perform energy management for the combination.

The control module of the load unit thus takes over the energy management in the combination and controls the combination. The control module may process location data and traffic data, energy data, information about route disruptions, information about loading points, weather data, and cargo data for the calculation and output of driving commands. In addition, the control module may be designed to determine the states of charge of the drive batteries of the transport units coupled in the combination, and to transfer electrical energy for optimizing the cruising range, battery capacity, and battery aging between the individual drive batteries of the transport units.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exploded illustration of a load unit having a control module,

FIG. 2 shows the load unit with a transport good,

FIG. 3 shows the load unit at a stationary charging station, and

FIG. 4 shows a combination of a load unit and multiple transport units.

### DETAILED DESCRIPTION

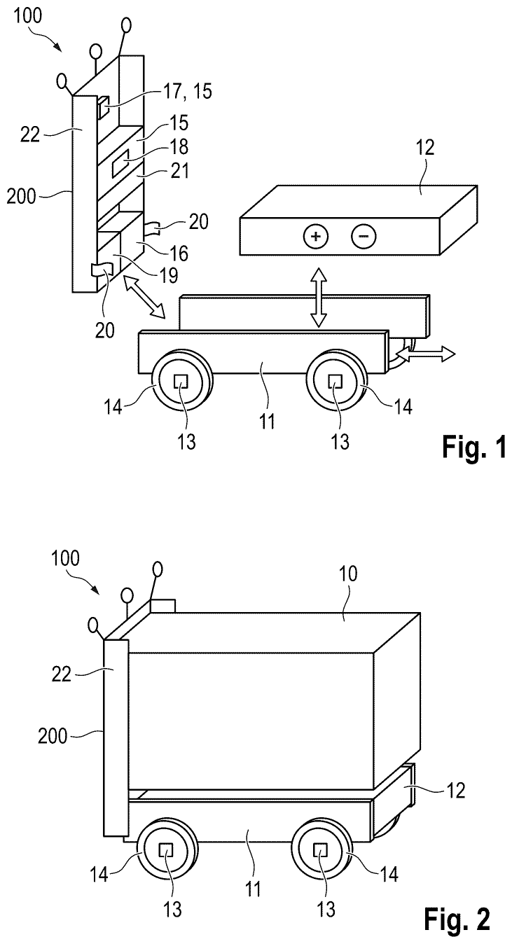

FIG. 1 shows an exploded illustration of a load unit 100 having a modular design. FIG. 2 shows the load unit 100 with a transport good 10 situated thereon. The load unit 100 is configured to receive at least one transport good 10 (FIG. 2) and transport it on a drivable surface. The load unit 100 includes a driving module 11 with a drive battery 12 and at least one electric drive 13 for driving wheels 14 of the load unit 100. The drive battery 12 may be removed from the driving module 11 and re-fastened to the driving module 11. In addition, the load unit 100 includes a control module 200. The control module 200 includes a sensor system 15 and a computing device 16. The computing device 16 is designed to evaluate data of the sensor system 15, and calculates driving commands for autonomous driving of the load unit 100, using the data of the sensor system 15. The computing device 16 outputs these driving commands to the driving module 11. The control module 200 is formed as an integrated unit which includes the sensor system 15 and the computing device 16. The control module 200 is detachably fastenable to the driving module 11 of the load unit 100. The control module 200 is designed to control the load unit 100 during high-speed travel at up to 90 km/h, for example.

The sensor system 15 includes cameras 17, radar sensors, lidar sensors, and a V2X unit 18 via which information about other road users and traffic infrastructure may be collected. The control module 200 also includes a battery 19 having a power capacity for the basic supply of the computing device 16 and/or the sensor system 15 for at least five days. For detachably fastening the control module 200 to the driving module 11, the control module 200 includes a fastener 20 which includes centering pins and an electromagnetic positioning device. The control module 200 also includes a communication device 21 for exchanging data with an external server. Fleet management may take place by use of the external server. The control module 200 is provided with aerodynamic cladding 22.

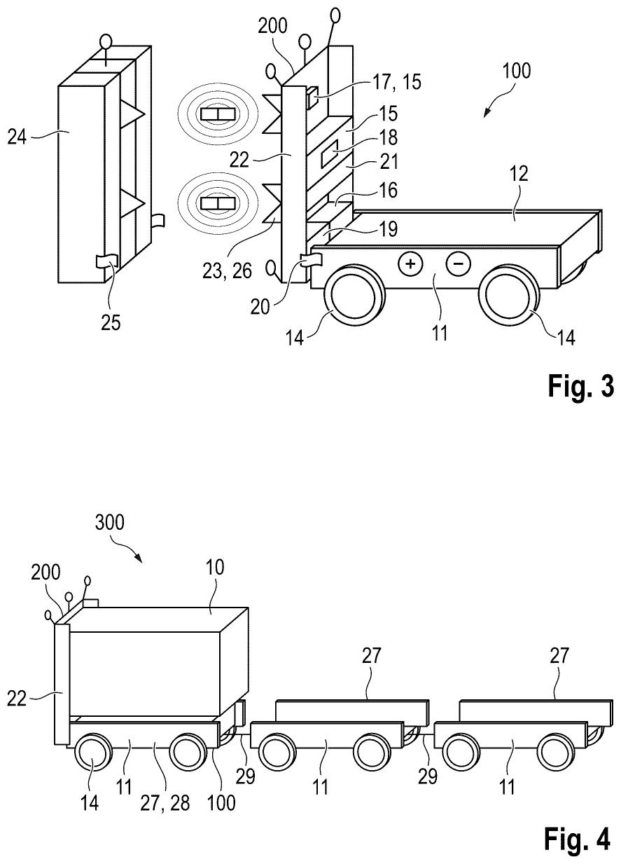

As shown in FIG. 3, for charging the battery 19 of the control module 200 the control module 200 has a charge interface 23 for charging via a stationary charging station 24. For charging the battery 19 of the control module 200, the load unit 100 is instructed by the control module 200 to approach the charging station 24 and transfer the control module 200 to the charging station 200. Appropriate fastening means 25 are provided for this purpose. The charge interface 23 is an inductive charge interface 26. When the battery 19 of the control module 200 is charged, the control module 200 may be removed from the stationary charging station 24 by a driving module 11 of a load unit 100.

FIG. 4 shows a combination 300 of multiple transport units 27. A first transport unit 28, viewed in the forward travel direction of the combination 300, is designed as a load unit 100 having a control module 200. Each of the further transport units 27 includes at least one driving module 11 of a load unit 100, and in principle may likewise be provided with a control module 200. The load unit 100 and the further transport units 27 are connected to one another via appropriate mechanical and electrical interfaces and data interfaces 29. Via the data interfaces 29, the control module 200 of the front load unit 100 may collect information about the further transport units 27 and in particular about the drive batteries 12 of the further transport units 27. The control module 200 performs energy management in the combination 300, and can transfer electrical energy between the drive batteries 12 of the load unit 100 or of the transport units 27 to allow an optimal battery capacity and service life of the drive batteries 12.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A load unit that is configured to receive at least one transport good and transport it on a drivable surface, the load unit comprising:
a driving module having a drive battery and at least one electric drive to drive at least one wheel of the load unit; and
a control module having a sensor system and a computing device, the computing device being designed to evaluate data of the sensor system and to calculate and output driving commands for autonomous driving of the load unit using the data of the sensor system,
wherein the control module, including the sensor system and the computing device, forms an integrated unit and is detachably fastenable to the driving module.

2. The load unit according to claim 1, wherein the control module (200) is designed to control the load unit during high-speed travel.

3. The load unit according to claim 1, wherein the sensor system (15) includes cameras (17) and/or radar sensors and/or lidar sensors and/or a V2X unit (18), in particular a V2V unit and/or a V2I unit and/or a V2P unit and/or a V2N unit.

4. The load unit according to claim 1, wherein the control module (200) includes communication devices (21) for exchanging data with an external server and/or with the electric drive (13) and/or other load units.

5. The load unit according to claim 1, wherein the control module (200) has a power supply, in particular a battery (19), for supplying power to the computing device (16) and/or the sensor system (15), the power supply preferably having a capacity for the basic supply of the computing device (16) and/or the sensor system (15) for at least three, preferably at least five, more preferably at least seven, days, and/or the power supply delivering a voltage of less than 60 V.

6. The load unit according to claim 1, wherein the control module (200) includes a fastener (20) for fastening to the driving module (11), wherein the fastener (20) includes centering pins and/or a wedge guide and/or an electromagnetic positioning device.

7. The load unit according to claim 1, wherein the control module (200) includes a cleaning device, in particular cleaning nozzles, for the sensor system (15).

8. The load unit according to claim 1, wherein the control module (200) has aerodynamic cladding (22).

9. The load unit according to claim 1, wherein the control module (200) has a charge interface (23) for charging the battery (19) via a stationary charging station (24).

10. The load unit according to claim 9, wherein the charge interface (23) is an inductive charge interface (26) or a charge interface with a plug attachment.

11. The load unit according to claim 1, wherein the load unit is designed, preferably by implementing driving commands of the control module (200), to approach the charging station (24) and transfer the control module (200) to the charging station (24) or remove it from the charging station (24).

12. The load unit according to claim 1, wherein the control module (200) has receptacles for a carrying device of a forklift, in particular fork eyes for a fork of a lift truck 13. A control module for the load unit according to claim 1, the control module comprising:
a sensor system; and
a computing device designed to evaluate data of the sensor system and to calculate driving commands using the data of the sensor system,
wherein the control module, including the sensor system and the computing device, forms an integrated unit and is detachably fastenable to the driving module of the load unit.

14. A combination of multiple transport units, wherein a transport unit or a first transport unit viewed in a forward travel direction of the combination has the load unit according to claim 1 and has a control module, and wherein each of the further transport units includes at least one driving module of the load unit.

15. The combination according to claim 14, wherein the control module of the transport unit configured as a load unit is designed to collect data concerning the drive batteries of the further transport units in the combination, and to perform energy management for the combination.
